(19) United States
(12) Patent Application Publication
(10) Pub. No.: US 2025/0091575 A1
(43) Pub. Date: Mar. 20, 2025

(54) VEHICLE CONTROL FUNCTION

(71) Applicant: QUALCOMM Incorporated, San Diego, CA (US)

(72) Inventors: Annika LARSSON, Göteborg (SE); Ida Karolina MATTSSON, Huddinge (SE)

(21) Appl. No.: 18/468,631

(22) Filed: Sep. 15, 2023

(51) Int. Cl. B60W 30/14; B60W 30/095; B60W 40/08; B60W 50/10; B60W 50/14; B60W 50/16

(52) U.S. Cl. CPC B60W 30/146; B60W 30/0956; B60W 40/08; B60W 50/10; B60W 50/16; B60W 2040/0818; B60W 2050/143; B60W 2050/146; B60W 2540/225; B60W 2540/229; B60W 2554/4044; B60W 2554/80; B60W 2556/45

(57) ABSTRACT

Disclosed are systems and techniques for providing vehicle control functions for vehicles. For example, a computing device can determine a field of view (FOV) of a driver of the vehicle based on driver sensor data. The computing device can compare the FOV of the driver with a predetermined threshold for the FOV of the driver. The computing device can determine a reduced FOV of the driver based on the FOV of the driver being less than the predetermined threshold for the FOV of the driver. The computing device can determine one or more objects relative to the vehicle based on traffic sensor data. The computing device can limit an amount of possible acceleration of the vehicle based on determining the reduced FOV of the driver and the one or more objects relative to the vehicle.

### FIELD

The present disclosure generally relates to driving assistance systems. For example, aspects of the present disclosure relate to a vehicle control functions (e.g., acceleration function) for vehicles.

### BACKGROUND

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for an vehicle control functions (e.g., an acceleration function for limiting acceleration and/or velocity of a vehicle in certain scenarios). According to at least one example, a method is provided for enabling vehicle acceleration control. The method includes: determining, by one or more processors of a vehicle and based on driver sensor data, a field of view (FOV) of a driver of the vehicle; determining, by the one or more processors, that the FOV of the driver is limited based on a FOV threshold, wherein the FOV threshold is one of a predetermined threshold angle for the FOV of the driver or a percentage of the predetermined threshold angle for the FOV of the driver; detecting, by the one or more processors of the vehicle and based on traffic sensor data, one or more objects within a threshold distance relative to the vehicle; and controlling, by the one or more processors of the vehicle, an amount of possible acceleration or velocity of the vehicle based on determining the FOV of the driver is limited and detecting the one or more objects within the threshold distance.

In another illustrative example, an apparatus for enabling vehicle acceleration control of a vehicle is provided. The apparatus includes at least one memory and at least one processor coupled to the at least one memory and configured to: determine, based on driver sensor data, a field of view (FOV) of a driver of the vehicle; determine that the FOV of the driver is limited based on a FOV threshold, wherein the FOV threshold is one of a predetermined threshold angle for the FOV of the driver or a percentage of the predetermined threshold angle for the FOV of the driver; detect, based on traffic sensor data, one or more objects within a threshold distance relative to the vehicle; and control an amount of possible acceleration or velocity of the vehicle based on determining the FOV of the driver is limited and detecting the one or more objects within the threshold distance.

In another illustrative example, a non-transitory computer-readable storage medium of a vehicle is provided that includes instructions stored thereon which, when executed by at least one processor, causes the at least one processor to: determine, based on driver sensor data, a field of view (FOV) of a driver of the vehicle; determine that the FOV of the driver is limited based on a FOV threshold, wherein the FOV threshold is one of a predetermined threshold angle for the FOV of the driver or a percentage of the predetermined threshold angle for the FOV of the driver; detect, based on traffic sensor data, one or more objects within a threshold distance relative to the vehicle; and control an amount of possible acceleration or velocity of the vehicle based on determining the FOV of the driver is limited and detecting the one or more objects within the threshold distance.

In another illustrative example, an apparatus is provided that includes: means for determining, by one or more processors of a vehicle and based on driver sensor data, a field of view (FOV) of a driver of the vehicle; means for determining, by the one or more processors, that the FOV of the driver is limited based on a FOV threshold, wherein the FOV threshold is one of a predetermined threshold angle for the FOV of the driver or a percentage of the predetermined threshold angle for the FOV of the driver; means for detecting, by the one or more processors of the vehicle and based on traffic sensor data, one or more objects within a threshold distance relative to the vehicle; and means for controlling, by the one or more processors of the vehicle, an amount of possible acceleration or velocity of the vehicle based on determining the FOV of the driver is limited and detecting the one or more objects within the threshold distance.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, is part of, or includes a vehicle (e.g., an automobile, truck, etc., or a component or system of an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LiDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is diagram illustrating a perspective view of an example of a motor vehicle with a driver monitoring system, in accordance with some aspects of the present disclosure.

FIG. 2 is a block diagram illustrating an example of an image processing configuration for a vehicle, in accordance with some aspects of the present disclosure.

FIG. 3 is a diagram illustrating an example of a vehicle stopped at an intersection of two roads, in accordance with some aspects of the present disclosure.

FIG. 4 is a diagram illustrating example scenarios of a driver with different field of view (FOVs), in accordance with some aspects of the present disclosure.

FIG. 5 is a flow chart illustrating an example of a detailed process for enabling an acceleration function, according to some aspects of the present disclosure.

FIG. 6 is a flow chart illustrating an example of a detailed process for disabling an acceleration function, according to some aspects of the present disclosure.

FIG. 7 is a flow chart illustrating an example of a process for enabling an acceleration function, according to some aspects of the present disclosure.

FIG. 8 is a flow chart illustrating an example of a process for disabling an acceleration function, according to some aspects of the present disclosure.

FIG. 9 illustrates an example computing system, according to aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Driver behavior, such as driver distraction, is a critical factor in most traffic accidents. Vehicles operated by distracted drivers can often lead to collisions with other vehicles, vulnerable road units (VRUs) (e.g., pedestrians), or other objects. Traffic accidents that involve vehicles colliding with VRUs, such as bicyclists or pedestrians crossing an intersection, can often lead to injuries or fatalities.

In order to avoid such collisions, vehicles are often implemented with an automatic emergency braking (AEB) functionality. AEB is an advanced driver assistance system (ADAS) that provides automatic braking based on sensor data to assist drivers to avoid collisions. The sensor data may be obtained by sensors (e.g., cameras, radar sensors, and/or light detection and ranging (LiDAR) sensors) mounted on the vehicle. When a vehicle determines, based on the sensor data, that a collision is imminent and that the driver is not reacting quickly enough to avoid the collision, AEB can be triggered. AEB, when triggered, will automatically cause the emergency brake in the vehicle to be engaged, which can cause the vehicle to come to an abrupt stop. AEB is often equipped with a forward crash warning (FCW) functionality. FCW can be used to alert the driver to a dangerous driving situation. FCW, when triggered, can use lights (e.g., display colored warning lights and/or textual warnings), sounds (e.g., audio sounds and/or warning messages), and/or vibrations (e.g., seat and/or steering wheel vibrations) to catch the driver's attention.

AEB can be triggered in various different driving scenarios. In one example driving scenario, a vehicle may be stopped at an intersection of roads. If the driver of the vehicle becomes distracted (e.g., by engaging in a secondary task, such as looking at their smart phone), the driver's attention may be directed to a narrower field of view, than if the driver was not distracted. When the driver's attention is directed to this narrower field of view, there can be an increase in risk that the driver will fail to detect objects (e.g., VRUs such as pedestrians, other vehicles, etc.) approaching and/or entering into the intersection. Driving scenarios of this type frequently exhibit the need for the driver or the vehicle to carry out an emergency braking maneuver. When the vehicle performs AEB, the emergency brake will be engaged to cause the vehicle to abruptly stop. This abrupt stop can cause the driver to experience a sudden, rough, jerky movement, which can reduce trust in the risk detection assistant systems of the vehicle and can significantly decrease the comfort and enjoyment of the driving experience for the driver. As such, improved systems and techniques to assist drivers to avoid collisions, while decreasing the amount of jerky movement from an AEB intervention, can be beneficial.

In one or more aspects of the present disclosure, systems, apparatuses, methods (also referred to as processes), and computer-readable media (collectively referred to herein as “systems and techniques”) are described herein that provide vehicle control functions. For example, the systems and techniques can provide vehicle acceleration control of a vehicle (e.g., an acceleration function for limiting acceleration and/or a velocity function for limiting velocity of a vehicle in certain scenarios). In one or more examples, the vehicle acceleration control can be enabled, without braking, due to the detection of objects (e.g., VRUs, other vehicles, etc.) approaching and/or entering into an area (e.g., an intersection, a parking lot, a driveway, or other area while the vehicle is stopped at the area), a determination of driver distraction (e.g., due to a reduced or limited driver field of view), and in some cases an intention of the driver to move (e.g., evidenced by a release of the brake or a press of the gas pedal).

In some aspects, a limited acceleration or velocity can be triggered or applied (e.g., causing a possible maximum acceleration to be limited) for a vehicle when objects (e.g., VRUs, other vehicles, etc.) are detected relative to the vehicle (e.g., detected within a threshold distance relative to the vehicle such as within five feet, ten feet or other threshold distance, detected as approaching or moving towards the vehicle, detected as moving relative to the vehicle), such as when an object is detected as entering an area (e.g., an intersection, parking lot, driveway, etc.) while the vehicle is at a standstill in the area (e.g., stopped at the intersection waiting at a stoplight or stop sign). In some examples, the driver can be informed (e.g., via an FCW) of the objects relative to the vehicle. The acceleration or velocity limitation can be removed when the driver is no longer distracted (e.g., the driver looks in many directions) and, as such, the driver's field of view is restored. Examples are described herein using an intersection as an example of an area in which the acceleration or velocity function can be applied. However, the systems and techniques can be applied to other types of areas, such as parking lots, driveways, drive throughs, etc.

In one or more examples, during operation for enabling vehicle acceleration or velocity control (e.g., when a vehicle is stopped in an area, such as at an intersection), one or more driver sensors of a vehicle can sense a gaze (and/or a head pose, such as the user's head being in a head down position) of a driver of the vehicle to produce driver sensor data. In one or more examples, the one or more driver sensors may be mounted within a passenger compartment of the vehicle, and may include cameras. The driver sensor data, including the gaze (and/or head pose, e.g., head position and orientation) of the driver, can be stored in memory of the vehicle.

One or more processors (e.g., of a driver monitoring system (DMS)) of the vehicle can determine a field of view (FOV) of the driver of the vehicle based on the driver sensor data (e.g., based on the gaze of the driver and in some cases a head pose of the driver). In one or more examples, the one or more processors of the vehicle can compare the FOV of the driver with a predetermined threshold for the FOV. The one or more processors of the vehicle can determine a reduced or limited FOV (e.g., a narrow FOV, which can be indicative of a distracted driver) of the driver based on the FOV of the driver being less than the predetermined threshold for the FOV. In one or more examples, the predetermined threshold for the FOV may be a predetermined threshold angle for the FOV of the driver or a percentage of the predetermined threshold angle for the FOV of the driver.

In some cases, the predetermined threshold can be used to determine a non-limited FOV and a limited FOV. For instance, in such cases, the predetermined threshold may be a threshold number of driver gazes (or glances) that fall within a particular FOV. For example, if the driver performs a number of gazes (or glances) within a particular FOV that is greater than the threshold number of driver gazes, the one or more processors can assign that particular FOV to the driver. In such cases, if the one or more processors determine that the user performs a number of gazes (or glances) within the full FOV that is below the threshold (e.g., there are too few or no glances by the driver to the side of the full FOV), then the one or more processors can determine that the user has a limited FOV.

In some examples, the one or more processors of the vehicle may determine (e.g., assume) a reduced or limited FOV of the driver based on a head pose and an eye gaze of the driver. For instance, the one or more processors of the vehicle may determine, based on the driver sensor data, that the head of the driver is rotated such that the driver is not viewing (e.g., looking away from) the road (e.g., the head of the driver is in a look away position), such as when the head of the driver is in a downward position, for a certain period of time. In such an example, the driver's gaze is narrowed and the head pose of the driver is oriented away from a forward position (e.g., looking down instead of looking forward through a windshield), indicating a limited FOV. The one or more processors of the vehicle can compare the certain period of time that the driver is not viewing the road with a predetermined threshold amount of time (e.g., for the driver to be looking away from the road). The one or more processors of the vehicles can determine (e.g., assume) a reduced or limited FOV of the driver based on the certain amount of time being greater than or equal to the threshold amount of time for the head of the driver to be in a look away position.

In some examples, the one or more processors of the vehicle may determine (e.g., assume) a reduced or limited FOV of the driver based on detecting that the user is engaging in an activity other than driving. For instance, the one or more processors can determine that the driver has a limited FOV in response to detecting that the driver is operating a mobile device (e.g., a cellular phone). In some cases, the one or more processors can determine that the driver has a limited FOV in response to detecting that the driver is engaging in an activity other than driving by processing the driver sensor data captured using the one or more driver sensors (e.g., one or more images captured using one or more cameras). For example, computer vision and/or a machine-learning model (e.g., a classification neural network) can process one or more images to detect an object (e.g., a mobile phone) in the one or more images, and can determine that the user is interacting with the object (e.g., operating the mobile phone) based on detecting the object in the one or more images. In response, the one or more processors can determine that the driver has a limited FOV.

One or more traffic sensors of the vehicle (e.g., mounted on or integrated with the vehicle) can sense an environment of the vehicle to produce traffic sensor data. In one or more examples, the one or more traffic sensors may include cameras, radar sensors, infrared sensors, and/or LiDAR sensors. The one or more processors of the vehicle may detect one or more objects relative to the vehicle based on the traffic sensor data, such as objects that are within a threshold distance relative to the vehicle, objects that are, moving relative to the vehicle, objects that are approaching the vehicle (e.g., approaching a side and/or a front of the vehicle), etc. In some aspects, the vehicle may obtain traffic sensor data from one or more other vehicles or from one or more road side units (RSUs). An RSU is a device that may transmit and receive messages over a communications link or interface (e.g., a cellular-based sidelink or PC5 interface, an 802.11 or WiFi™ based Dedicated Short Range Communication (DSRC) interface, and/or other interface) to and from one or more vehicles, other RSUs, base stations, etc. An example of messages that may be transmitted and received by an RSU includes vehicle-to-everything (V2X) messages. RSUs may be located on various transportation infrastructure systems, including stoplights, roads, bridges, parking lots, toll booths, and/or other infrastructure systems. In some examples, an RSU may facilitate communication between devices (e.g., vehicles, pedestrian user devices such as mobile devices, and/or other devices) and the transportation infrastructure systems. In some implementations, a RSU may be in communication with a server, base station, and/or other system that may perform centralized management functions.

In one or more examples, the one or more objects may include one or more VRUs (e.g., one or more pedestrians) or one or more other vehicles. The one or more processors of the vehicle can limit an amount of possible acceleration or velocity of the vehicle based on determining the limited FOV of the driver and the one or more objects relative to the vehicle (e.g., within a threshold distance relative to the vehicle, moving relative to the vehicle, approaching the vehicle such as are approaching the side and/or the front of the vehicle, etc.).

In one or more examples, the one or more processors of the vehicle can determine an intention to move (e.g., an intention to drive the vehicle) by the driver based on detecting a release of a brake pedal of the vehicle, a press of a gas pedal of the vehicle, and/or a shifting of a transmission of the vehicle to drive. The one or more processors of the vehicle can activate an FCW based on the determining of the intention to move by the driver. In one or more examples, the FCW may include a visual display warning, an audio warning, and/or a vibration.

In one or more aspects, during operation for disabling vehicle acceleration or velocity control (e.g., when a vehicle is stopped at an intersection or other area), one or more driver sensors of a vehicle can sense a gaze of a driver of the vehicle to produce driver sensor data. The driver sensor data, which includes the gaze of the driver, may be stored in memory of the vehicle.

One or more processors of the vehicle (e.g., a DMS of the vehicle) can determine a FOV of the driver of the vehicle based on the driver sensor data (e.g., based on the gaze of the driver). One or more processors of the vehicle can compare the FOV of the driver with a predetermined threshold for the FOV. The one or more processors of the vehicle can determine a non-limited FOV (e.g., a broad FOV, which can be indicative of an attentive driver) of the driver based on the FOV of the driver being greater than or equal to the predetermined threshold for the FOV. In one or more examples, the predetermined threshold for the FOV may be a predetermined threshold angle for the FOV of the driver, or a percentage of the predetermined threshold angle for the FOV of the driver. As noted previously, in some cases, the predetermined threshold can be used to determine a non-limited FOV and a limited FOV. For instance, in such cases, the predetermined threshold may be a threshold number of driver gazes (or glances) that fall within a particular FOV.

In some examples, one or more processors of the vehicle may determine, based on the driver sensor data, that the head of the driver is rotated such that the driver is not viewing (e.g., looking away from) the road (e.g., the head is in a look away position, for example when the head is in a downward position) for a certain amount of time. The one or more processors of the vehicle can compare the certain amount of time that the head of the driver is in a look away position with a predetermined threshold of an amount of time for the head of the driver to be in a look away position (e.g., looking away from the road). The one or more processors of the vehicles can determine (e.g., assume) a non-limited FOV of the driver based on the certain amount of time being less than the threshold amount of time for the head of the driver to be in a look away position.

The one or more traffic sensors of the vehicle can sense an environment of the vehicle to produce traffic sensor data and can determine that no objects relative to the vehicle based on the traffic sensor data, such as no objects within a threshold distance relative to the vehicle and/or moving relative to the vehicle, or no objects are approaching the vehicle (e.g., a side or a front of the vehicle). The one or more processors of the vehicle may release a limitation on an amount of possible acceleration or velocity of the vehicle based on the determining of the non-limited FOV of the driver and no objects relative to the vehicle (e.g., within a threshold distance relative to the vehicle, moving relative to, approaching the side or the front of the vehicle, etc.).

The use of the limited acceleration or velocity provided by the systems and techniques described herein can decrease the amount of sudden movement that a driver may experience from an AEB intervention. The limited acceleration or velocity can allow for fewer AEB interventions and for a smoother driving experience for the driver in densely populated, urban environments. A human machine interface (HMI) communication, such as via an FCW, can support the driver's reengagement with the driving task. While examples are described herein using limited acceleration, the systems and techniques described herein can be used for limiting velocity or other action of a vehicle.

Additional aspects of the present disclosure are described in more detail below.

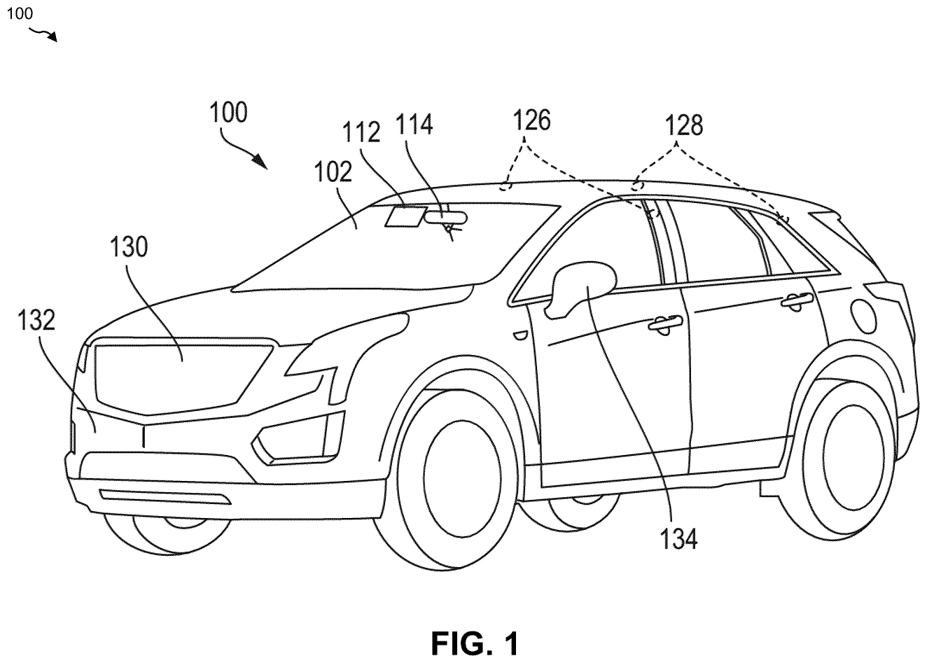

FIG. 1 is a perspective view of a motor vehicle with a driver monitoring system according to aspects of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some aspects, an additional camera may be located at the rear of the vehicle 100 and oriented such that the field of view of the additional camera captures a scene behind the vehicle 100 in the direction that the vehicle 100 is moving when in reverse mode or in a reverse direction. Although aspects of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although aspects of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle, with sufficient detail to discern a head rotation (e.g., a head down position) and/or a gaze direction (e.g., eye viewing direction) of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

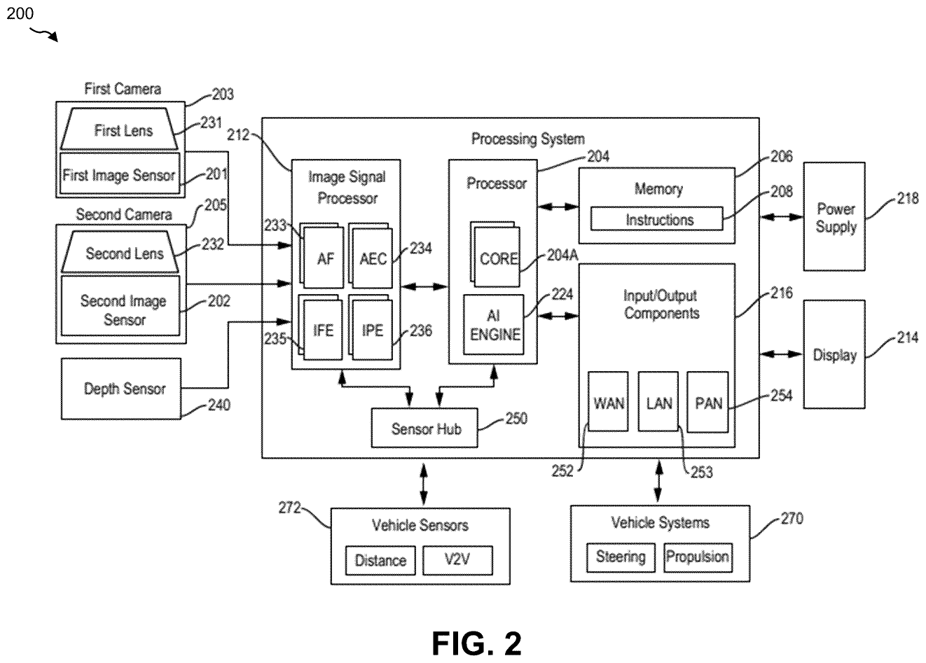

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one aspect, a local bus connection couples the image signal processor 212 to image sensors 201 and 202 of a first camera 203, which may correspond to camera 112 of FIG. 1, and second camera 205, which may correspond to camera 114 of FIG. 1, respectively. In another aspect, a wire interface may couple the image signal processor 212 to an external image sensor. In a further aspect, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some aspects, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some aspects, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some aspects, the vehicle 100 includes a system on chip (SoC) that incorporates the image signal processor 212, the processor 204. the sensor hub 250, the memory 206, and input/output components 216 into a single package.

In some aspects, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some aspects, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some aspects, the processor 204 may include ICs or other hardware (e.g., an artificial intelligence (AI) engine 224) in addition to the ability to execute software to cause the vehicle 100 to perform a number of functions or operations, such as the operations described herein. In some other aspects, the vehicle 100 does not include the processor 204, such as when all of the described functionality is configured in the image signal processor 212.

In some aspects, the display 214 may include one or more suitable displays or screens allowing for user interaction and/or to present items to the user, such as a preview of the image frames being captured by the image sensors 201 and 202. In some aspects, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some aspects involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

As previously mentioned, driver behavior, such as driver distraction, is a critical factor in most traffic accidents. In order to avoid collisions caused by driver distraction, vehicles are typically implemented with an automatic emergency braking (AEB) functionality. As noted previously, AEB is an advanced driver assistance system (ADAS) that can provide automatic braking based on sensor data to assist drivers to avoid collisions. AEB may be equipped with a forward crash warning (FCW) functionality, which can be used to alert the driver to a dangerous driving situation.

AEB can be triggered in various different driving scenarios. In one example driving scenario, a vehicle may be stopped at an intersection of roads. If the driver of the vehicle becomes distracted (e.g., by engaging in a secondary task, such as looking down at their smart phone or looking away from the road), the driver's attention may be directed to a narrower field of view, than if the driver was not distracted. When the driver's attention is directed to this narrower field of view, there can be an increase in risk that the driver will fail to detect objects (e.g., VRUs such as pedestrians, other vehicles, etc.) relative to the vehicle, such as within a threshold distance relative to the vehicle or approaching and/or entering into the intersection. Driving scenarios of this type usually need the driver or the vehicle to carry out an emergency braking maneuver. When the vehicle performs AEB, the emergency brake will engage to cause the vehicle to abruptly stop. This abrupt stop can cause the driver to experience a sudden, rough, jerky movement, which can reduce trust in the risk detection assistant systems of the vehicle and can significantly decrease the comfort and enjoyment of the driving experience for the driver.

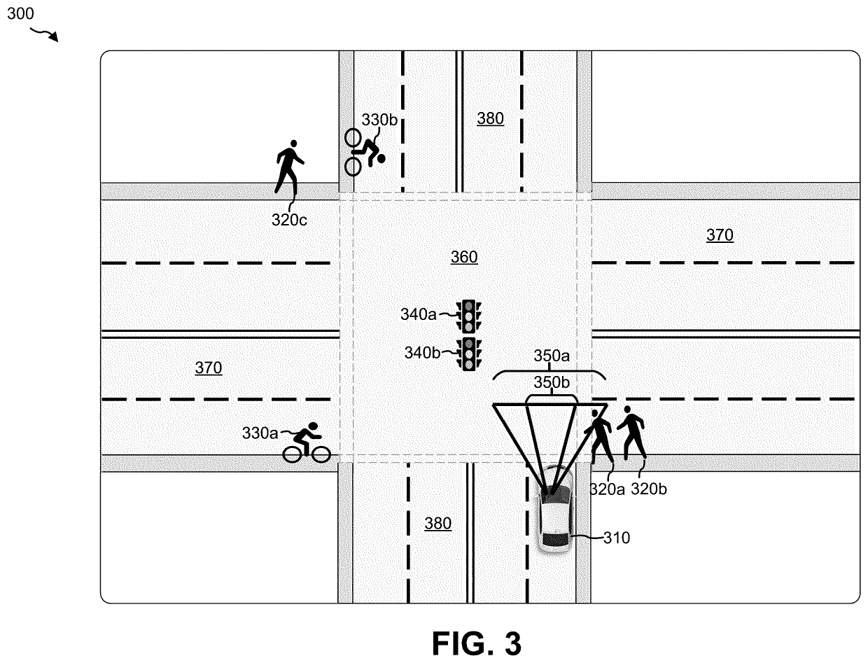

FIG. 3 shows an example of a vehicle stopped at an intersection. In particular, FIG. 3 is a diagram 300 illustrating an example of a vehicle 310 stopped at an intersection 360 of two roads 370, 380. In one or more examples, the vehicle 310 may be similarly equipped with sensors (e.g., cameras) as vehicle 100 of FIG. 1. For example the vehicle 310 may be equipped with camera 114 of FIG. 1 such that the camera 114 is able to capture (e.g., capture images and/or video of) a scene within the cabin (e.g., passenger compartment) of the vehicle 310. In one or more examples, the camera 114 within the cabin of the vehicle 310 may be oriented such that the FOV of the camera 114 can capture the head and/or face of the driver (e.g., user operator) of the vehicle 310 with sufficient detail to discern a head rotation (e.g., a position looking away from the intersection 360 ahead, which may be referred to as a “look away” position, such as a head down position) and/or a gaze direction (e.g., an eye viewing direction) of the driver of the vehicle 310.

In FIG. 3, within the area of the intersection 360 of the roads 370, 380, pedestrians 320a, 320b, 320c (as examples of VRUs), other VRUs 330a, 330b (e.g., in the form of bicyclists), and traffic lights 340a, 340b are shown. In the example of FIG. 3, two pedestrians 320a, 320b are shown to walking towards the intersection 360 to cross the road 380 right in front of the vehicle 310.

In one or more examples, when the driver of the vehicle 310 is not distracted, the FOV of the driver should be a typical, broad (e.g., non-limited) FOV of the intersection 360 ahead, which is illustrated in FIG. 3 as FOV 350a. In FIG. 3, the pedestrian 320a is shown to be located within the FOV 350a of the driver. Since the FOV 350a of the driver covers the pedestrian 320a, the driver is notified and aware of the presence of the pedestrian 320a crossing in front of the vehicle 310 and, as such, can avoid a collision with the pedestrian 320a.

However, when the driver of the vehicle 310 is distracted, such as looking down at an object (e.g., a mobile device, such as a cellular phone), the FOV of the driver will likely be a reduced or limited FOV, such is illustrated in FIG. 3 as FOV 350b. As shown in FIG. 3, the pedestrian 320a is not located within in the FOV 350b of the driver. Since the FOV 350b of the driver does not cover the pedestrian 320a, the driver is not notified or aware of the presence of the pedestrian 320a crossing in front of the vehicle 310. If the driver begins to accelerate the vehicle 310 with the pedestrian 320a present, the vehicle will need to perform an AEB, which will cause the vehicle 310 to stop abruptly, causing the driver to experience a jerky movement. As such, improved systems and techniques to assist drivers to avoid collisions, while decreasing the amount of jerky movement from an AEB intervention, can be useful.

In one or more aspects, the systems and techniques provide vehicle acceleration control of a vehicle (e.g., an intersection acceleration function). In one or more examples, the vehicle acceleration control can be enabled, without braking, due to the detection of objects (e.g., VRUs such as pedestrians, other vehicles, etc.) relative to the vehicle (e.g., within a threshold distance relative to the vehicle or approaching and/or entering into an intersection, such as while the vehicle is stopped at the intersection), an intention of the driver to move (e.g., evidenced by a release of the brake or a press of the gas pedal), and the determination of driver distraction (e.g., due to a reduced or limited driver field of view).

In one or more examples, a limited acceleration can be implemented (e.g., a possible maximum acceleration is limited) for a vehicle, when objects (e.g., VRUs, other vehicles, etc.) are detected relative to the vehicle (e.g., within a threshold distance relative to the vehicle, approaching and/or entering into an intersection, etc.), while the vehicle is at a standstill (e.g., at the intersection). In one or more examples, the driver can be informed (e.g., via an FCW) of the objects relative to the vehicle (e.g., objects within a threshold distance relative to the vehicle, approaching the vehicle, and/or moving relative to the vehicle). The acceleration limitation may be removed, when the driver is no longer distracted (e.g., the driver looks in many directions) and, as such, the driver's field of view is restored.

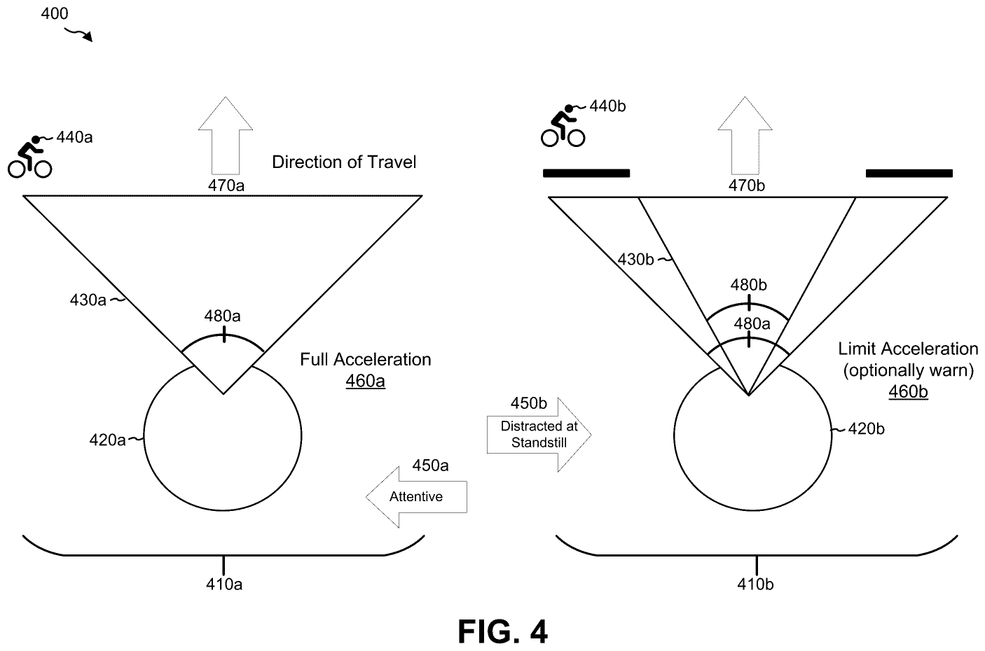

FIG. 4 shows examples of different allowable vehicle accelerations (e.g., a full acceleration or a limited acceleration) for different driver FOVs. In particular, FIG. 4 is a diagram illustrating example scenarios 400 of a driver 420a, 420b with different FOVs 430a, 430b. In FIG. 4, the example scenarios include 400 two scenarios 410a, 410b. In scenario 410a, a driver 420a is operating a vehicle (not shown) that is stopped at an intersection (not shown). The driver 420a is waiting to drive the vehicle in a direction denoted by arrow 470a (indicating direction of travel). A VRU 440a (e.g., in the form of a bicyclist) is shown to be traveling such that the VRU 440a is crossing the intersection in front of the vehicle of the driver 420a.

In scenario 410a of FIG. 4, the driver 420a is shown to have a typical, broad (e.g., non-limited) FOV 430a with an angle 480a. Since the FOV 430a of the driver 420a is shown to cover the VRU 440a, the driver 420a is notified and aware of the presence of the VRU 440a crossing in front of the vehicle of the driver 420a and, as such, the driver 420a can avoid a collision with the VRU 440a. Since the driver 420a has a non-limited FOV 430a, it can be assumed that the driver 420a is attentive 450a, and the acceleration of the vehicle does not need to be limited (e.g., full acceleration 460a of the vehicle is available).

In Scenario 410b, a driver 420b is operating a vehicle (not shown) that is stopped at an intersection (not shown). The driver 420b is waiting to drive the vehicle in a direction denoted by arrow 470b. A VRU 440b, in the form of a bicyclist, is traveling such that the VRU 440b is crossing the intersection in front of the vehicle of the driver 420b.

In scenario 410b, the driver 420b is shown to have a limited FOV 430b (also referred to as a reduced FOV) with an angle 480b. The angle 480b of the limited FOV 430b is smaller than the angle 480a of the non-limited FOV 430a. The FOV 430b of the driver 420b is shown to not cover the VRU 440b and, as such, the driver 420b is not aware of the presence of the VRU 440b crossing in front of the vehicle of the driver 420b. Since the driver 420b has a limited FOV 430b, it can be assumed that the driver 420b is distracted 450b (e.g., the driver is looking down at his smart phone). To avoid the possibility of an AEB being performed, the acceleration of the vehicle can be limited (e.g., full acceleration is not available) and the driver 420b can be warned 460b (e.g., via an FCW) of the presence of the VRU 440b.

In one or more examples, the use of a limited acceleration can decrease the amount of sudden, jerky movement that a driver can experience from an AEB intervention. The limited acceleration can allow for fewer AEB interventions and for a smoother driving experience for the driver in densely populated, urban environments. A human machine interface (HMI) communication, such as via an FCW, can support the driver's reengagement with the driving task.

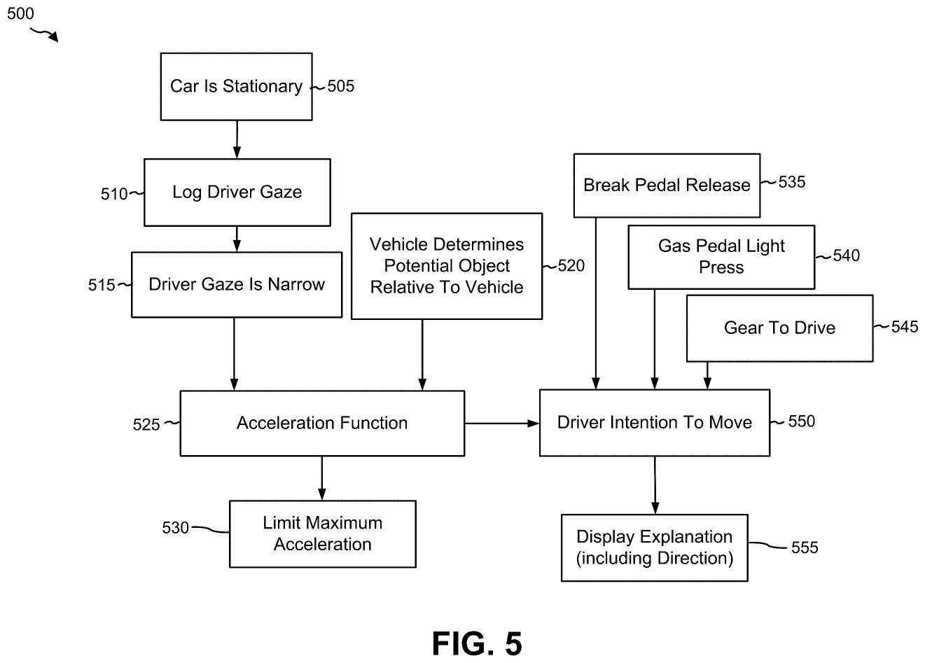

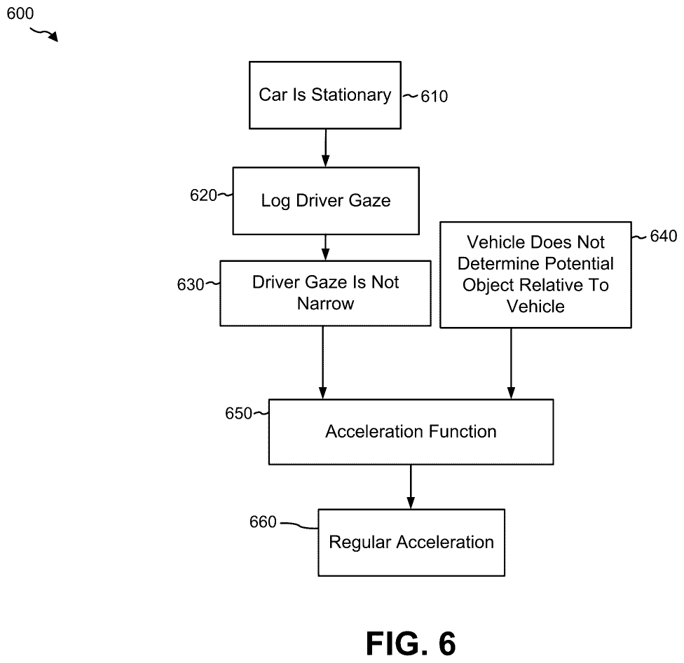

FIGS. 5 and 6 show examples of processes for enabling an acceleration function and disabling the acceleration function, respectively. In particular, FIG. 5 is a flow chart illustrating an example of a detailed process 500 for enabling an acceleration function.

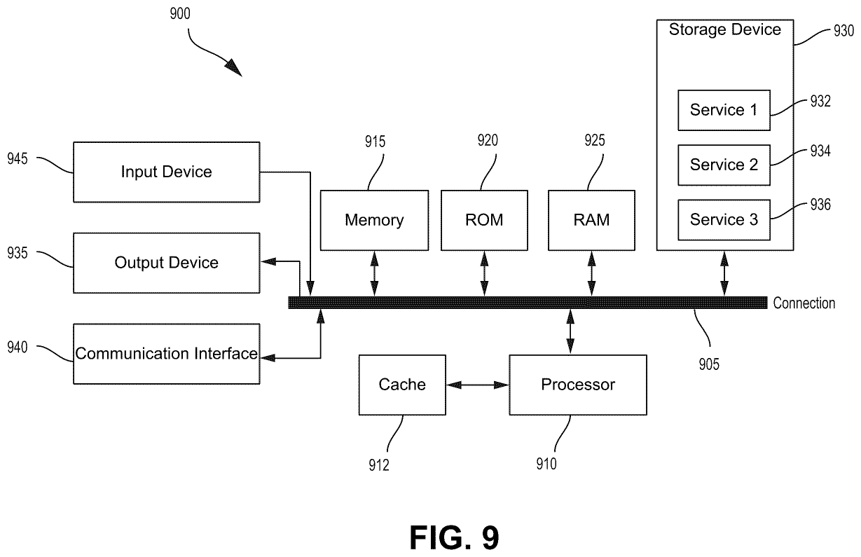

In one or more examples, during operation of the process 500 of FIG. 5 for enabling the acceleration function, at block 505, one or more processors (e.g., processor 910 of FIG. 9) of a vehicle can determine that the vehicle (e.g., car) is stationary, such as stopped at an intersection or other area (e.g., parking lot, driveway, etc.). One or more driver sensors of the vehicle can sense a gaze (and/or a head rotation, such as a head down position) of a driver of the vehicle to produce driver sensor data. In one or more examples, the one or more driver sensors may be mounted within a passenger compartment of the vehicle, and may include cameras (e.g., such as camera 114 of FIG. 1). At block 510, the driver sensor data, including the gaze (and/or head rotation) of the driver, can be stored (e.g., logged) in memory of the vehicle.

In one or more examples, the one or more processors of the vehicle can determine whether a FOV of the driver is limited (e.g., a reduced or limited FOV) based on analyzing the FOV of the driver or analyzing the driver sensor data, which can be indicative of the driver being attentive or distracted (e.g., interacting with an object, such as operating a mobile device).

In one or more examples, one or more processors (e.g., a driver monitoring system (DMS)) of the vehicle can determine a FOV of the driver of the vehicle based on the driver sensor data (e.g., based on the gaze of the driver). The one or more processors of the vehicle can compare the determined FOV of the driver with a predetermined threshold for the FOV of the driver. The one or more processors of the vehicle can determine a reduced or limited FOV (e.g., a narrow FOV, which can be indicative of a distracted driver) of the driver based on the FOV of the driver being less than the predetermined threshold for the FOV. In one or more examples, the predetermined threshold for the FOV may be a predetermined threshold angle (e.g., 90 degrees) for the FOV of the driver, or a percentage (e.g., 80 percent) of the predetermined threshold angle for the FOV of the driver.

In some cases, the predetermined threshold can be used to determine a non-limited FOV and a limited FOV. For instance, the predetermined threshold may be a threshold number of driver gazes (or glances) (e.g., three gazes, ten gazes, etc.) that fall within a particular FOV (e.g., within a particular period of time, such as ten seconds, thirty seconds, one minute, etc.). In such an example, if the driver performs a number of gazes (or glances) within a particular FOV that is greater than the threshold number of driver gazes, the one or more processors can assign that particular FOV to the driver. If the one or more processors determine that the user performs a number of gazes (or glances) within the full FOV that is below the threshold (e.g., there are too few or no glances by the driver to the side of the full FOV), then the one or more processors can determine that the user has a limited FOV. Referring to FIG. 4 as an illustrative example, the one or more processors may determine that a number of gazes by the driver outside of the limited FOV 430b is less than the threshold number of driver gazes and, in response, may determine that the driver's FOV is limited (e.g., is confined to the limited FOV 430b). In some examples, if the number of gazes by the driver outside of the limited FOV 430 become greater than the threshold number of driver gazes, the one or more processors may determine that the user's FOV has returned to the non-limited FOV 430a.

In some examples, the one or more processors of the vehicle can determine (e.g., assume) a reduced or limited FOV of the driver based on a head pose and an eye gaze of the driver. For instance, the one or more processors of the vehicle can determine, based on the driver sensor data, that the head of the driver is rotated such that the driver is not viewing (e.g., looking away from) the road (e.g., the head of the driver is in a “look away” position, such as when the head of the driver is in a downward position) for a certain period of time. In such an example, the driver's gaze is narrowed and the head pose of the driver is oriented away from a forward position (e.g., looking down instead of looking forward through a windshield), indicating a limited FOV. The one or more processors of the vehicle can compare the certain period of time that the driver is not viewing the road (e.g., is in a look away position) with a predetermined threshold amount of time (e.g., for the driver to be looking away from the road). The one or more processors of the vehicles can determine (e.g., assume) a reduced or limited FOV of the driver based on the certain amount of time being greater than or equal to the threshold amount of time for the head of the driver to be in a look away position. At block 510. the one or more processors may determine that the driver has a reduced or limited FOV (e.g., a narrow gaze).

In one or more examples, one or more traffic sensors of the vehicle (e.g., mounted on or integrated within the vehicle) can sense an environment of the vehicle to produce traffic sensor data. In some examples, the one or more traffic sensors may include cameras, radar sensors, infrared sensors, and/or LiDAR sensors. The one or more processors of the vehicle can detect one or more objects relative to the vehicle based on the traffic sensor data, such as one or more objects within a threshold distance relative to the vehicle, moving relative to the vehicle, and/or that are approaching the vehicle (e.g., approaching a side and/or a front of the vehicle). In one or more examples, the one or more objects may include one or more VRUs (e.g., one or more pedestrians), one or more other vehicles, and/or other objects. At block 520, the one or more processors of the vehicle may detect one or more objects relative to the vehicle, such as one or more objects that are approaching the vehicle (e.g., a potential threat, such as a person, from the side of the vehicle).

At block 525, the one or more processors of the vehicle can enable the acceleration function based on determining that the driver has a reduced or limited FOV and that one or more objects are detected relative to the vehicle, such as moving relative to the vehicle within a threshold distance relative to the vehicle, and/or approaching the vehicle (e.g., are approaching the side and/or the front of the vehicle). At block 530, the one or more processors of the vehicle can limit an amount of possible acceleration of the vehicle based on the acceleration function being enabled.

In one or more examples, at block 535, the one or more processors of the vehicle can detect a release of the brake pedal by the driver of the vehicle. At block 540, the one or more processors of the vehicle can detect a light press of the gas pedal by the driver of the vehicle. At block 545, the one or more processors of the vehicle can detect shifting of the gears of the transmission of the vehicle to drive (D) by the driver of the vehicle.

In one or more examples, the one or more processors of the vehicle can determine an intention to move (e.g., an intention to drive the vehicle) by the driver based on detecting a release of the brake pedal of the vehicle, a press of the gas pedal of the vehicle, and/or a shifting of the transmission of the vehicle to drive. At block 550, the one or more processors of the vehicle may determine that the driver has an intention to move based on the detection of a release of the brake pedal of the vehicle, the detection of a press of the gas pedal of the vehicle, and/or the detection of a shifting of the transmission of the vehicle to drive.

At block 555, the one or more processors of the vehicle can activate an FCW (e.g., display a textual explanation warning, which may include directions to avoid the collision) based on the determining of the intention to move by the driver. In one or more examples, the FCW may include a visual display warning (e.g., color warning lights and/or textual warnings), an audio warning (e.g., audio sounds and/or warning messages), and/or a vibration (e.g., seat and/or steering wheel vibrations) to grab the driver's attention.

FIG. 6 is a flow chart illustrating an example of a detailed process 600 for disabling an acceleration function. In one or more examples, during operation of the process 600 of FIG. 6 for disabling the acceleration function, at block 610, one or more processors (e.g., processor 910 of FIG. 9) of a vehicle can determine that the vehicle (e.g., car) is stationary, such as stopped at an intersection or other area (e.g., a parking lot, driveway, etc.). One or more driver sensors of the vehicle can sense a gaze (and/or a head rotation, such as a head down position) of a driver of the vehicle to obtain driver sensor data. The one or more driver sensors can be mounted in a cabin (e.g., a passenger compartment) of the vehicle, and may include cameras (e.g., camera 114 of FIG. 1). At block 620, the driver sensor data, which includes the gaze (and/or head rotation) of the driver, may be stored (e.g., logged) into memory of the vehicle.

In one or more examples, the one or more processors of the vehicle can determine whether a FOV of the driver is non-limited (e.g., a non-limited FOV) based on analyzing the FOV of the driver or analyzing the driver sensor data, which can be indicative of the driver being attentive or distracted.

In one or more examples, a DMS of the vehicle may determine a FOV of the driver of the vehicle based on the driver sensor data (e.g., based on the gaze of the driver). The one or more processors of the vehicle may compare the determined FOV of the driver with a predetermined threshold for the FOV of the driver. The one or more processors of the vehicle may determine a non-limited FOV (e.g., a typical, broad FOV, which can be indicative of an attentive driver) of the driver based on the FOV of the driver being greater than or equal to the predetermined threshold for the FOV. In one or more examples, the predetermined threshold for the FOV can be a predetermined threshold angle for the FOV of the driver or a percentage of the predetermined threshold angle for the FOV of the driver.

In some examples, the one or more processors of the vehicle may determine, based on the driver sensor data, that the head of the driver is rotated such that the driver is not viewing (e.g., looking away from) the road (e.g., the head of the driver is in a “look away” position) for a certain period of time. The one or more processors of the vehicle may compare the certain period of time that the head of the driver is in a look away position with a predetermined threshold amount of time for the head of the driver to be in a look away position. The one or more processors of the vehicles may determine a non-limited FOV of the driver based on the certain amount of time being less than the threshold amount of time for the head of the driver to be in a look away position. At block 630, the one or more processors may determine that the driver has a non-limited FOV (e.g., not a narrow gaze).

In some examples, one or more traffic sensors of the vehicle, which may be mounted on or integrated in the vehicle, may sense an environment of the vehicle to obtain traffic sensor data. In one or more examples, the one or more traffic sensors may include cameras, radar sensors, infrared sensors, and/or LiDAR sensors. The one or more processors of the vehicle may (or may not) detect objects are relative to the vehicle based on the traffic sensor data (e.g., objects within a threshold distance relative to the vehicle, moving relative to the vehicle, and/or approaching the vehicle, such as approaching a side and/or a front of the vehicle). In one or more examples, the one or more objects may include one or more VRUs (e.g., one or more pedestrians), one or more other vehicles, and/or other objects. At block 640, the one or more processors of the vehicle may detect that no objects are relative to the vehicle (e.g., no potential threat is detected), such as within a threshold distance relative to the vehicle, moving relative to the vehicle, approaching the vehicle, etc.

At block 650, the one or more processors of the vehicle can disable the acceleration function based on determining that the driver has a non-limited FOV and that there are no objects relative to the vehicle. At block 660, the one or more processors of the vehicle can allow for the full amount of possible acceleration of the vehicle based on the acceleration function being disabled.

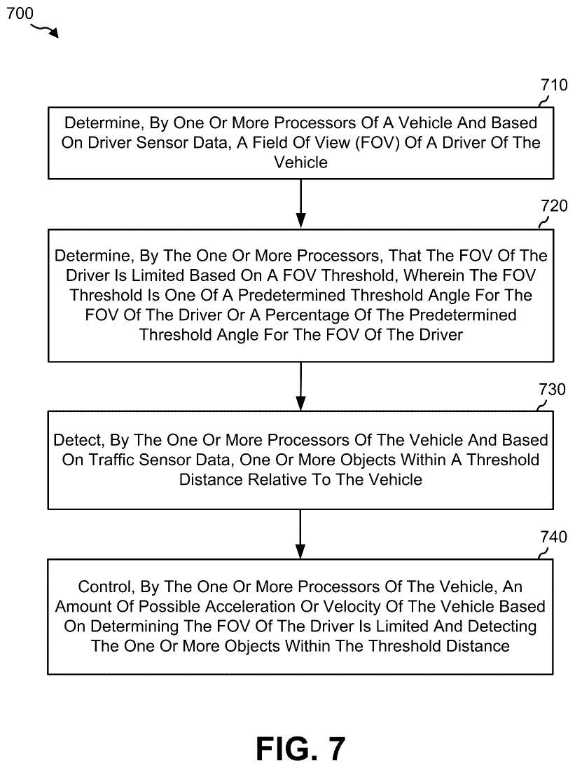

FIG. 7 is a flow chart illustrating an example of a process 700 for enabling an acceleration function. The process 700 can be performed by a device or by a component, system, or apparatus of the device (e.g., a chipset of the device, one or more processors of the device, or other component or system of the device). The device may be a vehicle (e.g., vehicle 100 of FIG. 1, or vehicle 310 of FIG. 3), may be a part of or within a vehicle, or other device. The operations of the process 700 may be implemented as software components that are executed and run on one or more processors (e.g., processor 910 of FIG. 9 or other processor(s)) of the device. Further, the transmission and reception of signals by the device in the process 700 may be enabled, for example, by one or more antennas and/or one or more transceivers (e.g., wireless transceiver(s)) of the device.

At block 710, the device (or component thereof) can determine a field of view (FOV) (e.g., FOV 430a) of a driver of the vehicle based on driver sensor data. In some cases, the device (or component thereof) can determine the FOV of the driver based on a pre-determined number of gazes of the driver being within the FOV. For instance, as described previously, if the driver performs a number of gazes (or glances) within the FOV that is greater than a threshold number of driver gazes, the device (or component thereof) can assign that FOV to the driver.

At block 720, the device (or component thereof) can determine that the FOV of the driver is limited based on a FOV threshold. For example, as noted previously, the predetermined threshold for the FOV can include a predetermined threshold angle for the FOV of the driver or a percentage of the predetermined threshold angle for the FOV of the driver. In some cases, the device (or component thereof) can compare the FOV of the driver with a predetermined threshold for the FOV of the driver and can determine that the FOV of the driver is limited based on the FOV of the driver being less than the FOV threshold. In some examples, as previously described, the predetermined threshold may be a threshold number of driver gazes (or glances). For instance, if the device (or component thereof) determines that the user performs a number of gazes (or glances) within the FOV that is below the threshold number of driver gazes (e.g., which can indicate that there are too few or no glances by the driver to the side of the full FOV), then the device (or component thereof) can determine that the user has a limited FOV.

In some cases, to determine the FOV of the driver is limited, the device (or component thereof) can determine, based on the driver sensor data, a head of the driver is rotated in a position looking away from a road on which the vehicle is traveling for a period of time. The device (or component thereof) can compare the period of time with a predetermined threshold amount of time for the head of the driver looking away from the road. The device (or component thereof) can determine the FOV of the driver limited based on the period of time being greater than or equal to the predetermined threshold amount of time.

At block 730, the device (or component thereof) can detect, based on traffic sensor data, one or more objects relative to the vehicle. For instance, the device (or component thereof) can determine one or more objects are within a threshold distance relative to the vehicle (and/or are moving relative to the vehicle and/or approaching the vehicle, such as approaching the side and/or the front of the vehicle). In one illustrative example, the device (or component thereof) can determine that a pedestrian is moving relative to the vehicle and that a distance between the pedestrian and the vehicle is reducing as the pedestrian is moving. The one or more objects can include vulnerable road users (VRUs) (e.g., one or more pedestrians) or one or more other vehicles.

At block 740, the device (or component thereof) can control an amount of possible acceleration (or velocity) of the vehicle based on determining the reduced FOV of the driver and detecting the one or more objects within the threshold distance relative to the vehicle. For instance, the device (or component thereof) can restrict the amount of acceleration allowed by the vehicle to no (zero) acceleration or to a maximum acceleration (e.g., 0.1 g of acceleration) that is less than normal operating acceleration (e.g., 1 g of acceleration) of the vehicle.

In some aspects, the device (or component thereof) can determine an intention to move by the driver based on detecting a release of a brake pedal of the vehicle, a press of a gas pedal of the vehicle, a shifting of a transmission of the vehicle to drive, or other action indicative of an intention of the driver to move. In some cases, the device (or component thereof) can activate a forward collision warning (FCW) based on determining the intention to move by the driver. In some examples, the FCW includes a visual display warning, an audio warning, a vibration, and/or other output. The FCW can be output to a display of the vehicle and/or to a device of a driver or passenger of the vehicle (e.g., an extended reality (XR) device such as an augmented reality (AR) or mixed reality (MR) device, a mobile device, or other device).

In some cases, the device (or component thereof) can obtain the driver sensor data using one or more driver sensors of the vehicle. For example, the device (or component thereof) may sense, using the driver sensors of the vehicle, the driver of the vehicle to obtain the driver sensor data. In some cases, the driver sensors can include or be part of an occupant sensing system and/or driver monitoring system. The driver sensors can include any type of sensor, such as one or more cameras, infrared sensors, radar sensors, LIDAR sensors, any combination thereof, and/or other sensors. In some examples, the device (or component thereof) can obtain the traffic sensor data using one or more traffic sensors of the vehicle directed to an environment of the vehicle. Additionally or alternatively, in some cases, the device (or component thereof) can obtain the traffic sensor data from at least one of another vehicle or a roadside unit (RSU) (e.g., via one or more V2X or DSRC messages).

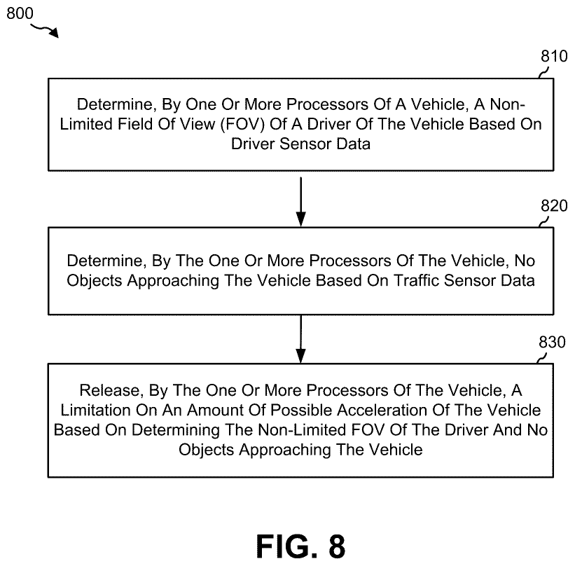

FIG. 8 is a flow chart illustrating an example of a process 800 for disabling an acceleration function. The process 800 can be performed by a device or by a component, system, or apparatus of the device (e.g., a chipset of the device, one or more processors of the device, or other component or system of the device). The device may be a vehicle (e.g., vehicle 100 of FIG. 1, or vehicle 310 of FIG. 3), a part of or within a vehicle, or other device. The operations of the process 800 may be implemented as software components that are executed and run on one or more processors (e.g., processor 910 of FIG. 9 or other processor(s)) of the device. Further, the transmission and reception of signals by the device in the process 800 may be enabled, for example, by one or more antennas and/or one or more transceivers (e.g., wireless transceiver(s)) of the device.

At block 810, the device (or component thereof) can determine a non-limited field of view (FOV) of a driver of the vehicle based on driver sensor data.

At block 820, the device (or component thereof) can determine no objects relative to the vehicle based on traffic sensor data.

At block 830, the device (or component thereof) can release a limitation on an amount of possible acceleration of the vehicle based on determining the non-limited FOV of the driver and that no objects relative to the vehicle.

In some examples, the device may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 and process 800 are each illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700, process 800, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed by the disclosed system for spatio-temporal cooperative learning for multi-sensor fusion. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 can include a cache 1212 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LIDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C. A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. A method for enabling vehicle acceleration control, the method comprising: determining, by one or more processors of a vehicle and based on driver sensor data, a field of view (FOV) of a driver of the vehicle; determining, by the one or more processors, that the FOV of the driver is limited based on a FOV threshold, wherein the FOV threshold is one of a predetermined threshold angle for the FOV of the driver or a percentage of the predetermined threshold angle for the FOV of the driver; detecting, by the one or more processors of the vehicle and based on traffic sensor data, one or more objects within a threshold distance relative to the vehicle; and controlling, by the one or more processors of the vehicle, an amount of possible acceleration or velocity of the vehicle based on determining the FOV of the driver is limited and detecting the one or more objects within the threshold distance.
Aspect 2. The method of Aspect 1, wherein determining, by the one or more processors, the FOV of the driver is limited comprises: determining, by the one or more processors based on the driver sensor data, a head of the driver is rotated in a position looking away from a road on which the vehicle is traveling for a period of time; comparing, by the one or more processors, the period of time with a predetermined threshold amount of time for the head of the driver looking away from the road; and determining, by the one or more processors, the FOV of the driver is limited based on the period of time being greater than or equal to the predetermined threshold amount of time.
Aspect 3. The method of any one of Aspects 1 or 2, further comprising determining, by the one or more processors of the vehicle, an intention to move by the driver based on detecting at least one of a release of a brake pedal of the vehicle, a press of a gas pedal of the vehicle, or a shifting of a transmission of the vehicle to drive.
Aspect 4. The method of Aspect 3, further comprising activating, by the one or more processors of the vehicle, a forward collision warning (FCW) based on determining the intention to move by the driver.
Aspect 5. The method of Aspect 4, wherein the FCW comprises at least one of a visual display warning, an audio warning, or a vibration.
Aspect 6. The method of any one of Aspects 1 to 5, wherein the one or more objects comprise at least one of one or more vulnerable road users (VRUs) or one or more other vehicles.
Aspect 7. The method of any one of Aspects 1 to 6, further comprising sensing, by one or more driver sensors of the vehicle, the driver of the vehicle to obtain the driver sensor data.
Aspect 8. The method of any one of Aspects 1 to 7, further comprising sensing, by one or more traffic sensors of the vehicle, an environment of the vehicle to obtain the traffic sensor data.
Aspect 9. The method of any one of Aspects 1 to 8, further comprising obtaining the traffic sensor data from at least one of another vehicle or a roadside unit (RSU).
Aspect 10. The method of any one of Aspects 1 to 9, further comprising determining that the FOV of the driver is limited based on the FOV of the driver being less than the FOV threshold.
Aspect 11. The method of any one of Aspects 1 to 10, wherein the one or more objects are detected as approaching the vehicle.
Aspect 12. The method of any one of Aspects 1 to 11, wherein the FOV of the driver is determined based on a pre-determined number of gazes of the driver being within the FOV.
Aspect 13. An apparatus for enabling vehicle acceleration control of a vehicle, the apparatus comprising: at least one memory; and at least one processor coupled to the at least one memory and configured to: determine, based on driver sensor data, a field of view (FOV) of a driver of the vehicle; determine that the FOV of the driver is limited based on a FOV threshold, wherein the FOV threshold is one of a predetermined threshold angle for the FOV of the driver or a percentage of the predetermined threshold angle for the FOV of the driver; detect, based on traffic sensor data, one or more objects within a threshold distance relative to the vehicle; and control an amount of possible acceleration or velocity of the vehicle based on determining the FOV of the driver is limited and detecting the one or more objects within the threshold distance.
Aspect 14. The apparatus of Aspect 13, wherein, to determine the FOV of the driver is limited, the at least one processor is configured to: determine, based on the driver sensor data, a head of the driver is rotated in a position looking away from a road on which the vehicle is traveling for a period of time; compare the period of time with a predetermined threshold amount of time for the head of the driver looking away from the road; and determine the FOV of the driver is limited based on the period of time being greater than or equal to the predetermined threshold amount of time.
Aspect 15. The apparatus of any one of Aspects 13 or 14, wherein the at least one processor is configured to determine an intention to move by the driver based on detecting at least one of a release of a brake pedal of the vehicle, a press of a gas pedal of the vehicle, or a shifting of a transmission of the vehicle to drive.
Aspect 16. The apparatus of Aspect 15, wherein the at least one processor is configured to activate a forward collision warning (FCW) based on determining the intention to move by the driver.
Aspect 17. The apparatus of Aspect 16, wherein the FCW comprises at least one of a visual display warning, an audio warning, or a vibration.
Aspect 18. The apparatus of any one of Aspects 13 to 17, wherein the one or more objects comprise at least one of one or more vulnerable road users (VRUs) or one or more other vehicles.
Aspect 19. The apparatus of any one of Aspects 13 to 18, wherein the at least one processor is configured to obtain the driver sensor data using one or more driver sensors of the vehicle.
Aspect 20. The apparatus of any one of Aspects 13 to 19, wherein the at least one processor is configured to obtain the traffic sensor data using one or more traffic sensors of the vehicle directed to an environment of the vehicle.
Aspect 21. The apparatus of any one of Aspects 13 to 20, wherein the at least one processor is configured to obtain the traffic sensor data from at least one of another vehicle or a roadside unit (RSU).
Aspect 22. The apparatus of any one of Aspects 13 to 21, wherein the at least one processor is configured to determine the FOV of the driver based on a pre-determined number of gazes of the driver being within the FOV.
Aspect 23. The apparatus of any one of Aspects 13 to 22, wherein the at least one processor is configured to determine that the FOV of the driver is limited based on the FOV of the driver being less than the FOV threshold.
Aspect 24. The apparatus of any one of Aspects 13 to 23, the one or more objects are detected as approaching the vehicle.
Aspect 25. The apparatus of any one of Aspects 13 to 24, wherein the apparatus is part of the vehicle.
Aspect 26. The apparatus of any one of Aspects 13 to 25, wherein the apparatus is the vehicle.
Aspect 27. A non-transitory computer-readable storage medium of a vehicle comprising instructions stored thereon which, when executed by at least one processor, causes the at least one processor to perform operations according to any of Aspects 1 to 12.
Aspect 28. An apparatus comprising one or more means for performing operations according to any of Aspects 1 to 12.
Aspect 29. A method for disabling vehicle acceleration control, the method comprising: determining, by one or more processors of a vehicle, a non-limited field of view (FOV) of a driver of the vehicle based on driver sensor data; determining, by the one or more processors of the vehicle, no objects relative to the vehicle based on traffic sensor data; and releasing, by the one or more processors of the vehicle, a limitation on an amount of possible acceleration of the vehicle based on determining the non-limited FOV of the driver and that no objects relative to the vehicle.
Aspect 30. An apparatus for disabling vehicle acceleration control of a vehicle, the apparatus comprising: at least one memory; and at least one processor coupled to the at least one memory and configured to: determine a non-limited field of view (FOV) of a driver of the vehicle based on driver sensor data; determine no objects relative to the vehicle based on traffic sensor data; and release a limitation on an amount of possible acceleration of the vehicle based on determining the non-limited FOV of the driver and that no objects relative to the vehicle.
Aspect 31. A non-transitory computer-readable storage medium of a vehicle comprising instructions stored thereon which, when executed by at least one processor, causes the at least one processor to perform operations according to Aspect 29.
Aspect 32. An apparatus comprising one or more means for performing operations according to Aspect 29.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for enabling vehicle acceleration control, the method comprising:
determining, by one or more processors of a vehicle and based on driver sensor data, a field of view (FOV) of a driver of the vehicle;
determining, by the one or more processors, that the FOV of the driver is limited based on a FOV threshold, wherein the FOV threshold is one of a predetermined threshold angle for the FOV of the driver or a percentage of the predetermined threshold angle for the FOV of the driver;
detecting, by the one or more processors of the vehicle and based on traffic sensor data, one or more objects within a threshold distance relative to the vehicle; and
controlling, by the one or more processors of the vehicle, an amount of possible acceleration or velocity of the vehicle based on determining the FOV of the driver is limited and detecting the one or more objects within the threshold distance.

2. The method of claim 1, wherein determining, by the one or more processors, the FOV of the driver is limited comprises:
determining, by the one or more processors based on the driver sensor data, a head of the driver is rotated in a position looking away from a road on which the vehicle is traveling for a period of time;
comparing, by the one or more processors, the period of time with a predetermined threshold amount of time for the head of the driver looking away from the road; and
determining, by the one or more processors, the FOV of the driver is limited based on the period of time being greater than or equal to the predetermined threshold amount of time.

3. The method of claim 1, further comprising determining, by the one or more processors of the vehicle, an intention to move by the driver based on detecting at least one of a release of a brake pedal of the vehicle, a press of a gas pedal of the vehicle, or a shifting of a transmission of the vehicle to drive.

4. The method of claim 3, further comprising activating, by the one or more processors of the vehicle, a forward collision warning (FCW) based on determining the intention to move by the driver.

5. The method of claim 4, wherein the FCW comprises at least one of a visual display warning, an audio warning, or a vibration.

6. The method of claim 1, wherein the one or more objects comprise at least one of one or more vulnerable road users (VRUs) or one or more other vehicles.

7. The method of claim 1, further comprising sensing, by one or more driver sensors of the vehicle, the driver of the vehicle to obtain the driver sensor data.

8. The method of claim 1, further comprising sensing, by one or more traffic sensors of the vehicle, an environment of the vehicle to obtain the traffic sensor data.

9. The method of claim 1, further comprising obtaining the traffic sensor data from at least one of another vehicle or a roadside unit (RSU).

10. The method of claim 1, further comprising determining that the FOV of the driver is limited based on the FOV of the driver being less than the FOV threshold.

11. The method of claim 1, wherein the one or more objects are detected as approaching the vehicle.

12. The method of claim 1, wherein the FOV of the driver is determined based on a pre-determined number of gazes of the driver being within the FOV.

13. An apparatus for enabling vehicle acceleration control of a vehicle, the apparatus comprising:
at least one memory; and
at least one processor coupled to the at least one memory and configured to:
determine, based on driver sensor data, a field of view (FOV) of a driver of the vehicle;
determine that the FOV of the driver is limited based on a FOV threshold, wherein the FOV threshold is one of a predetermined threshold angle for the FOV of the driver or a percentage of the predetermined threshold angle for the FOV of the driver;
detect, based on traffic sensor data, one or more objects within a threshold distance relative to the vehicle; and
control an amount of possible acceleration or velocity of the vehicle based on determining the FOV of the driver is limited and detecting the one or more objects within the threshold distance.

14. The apparatus of claim 13, wherein, to determine the FOV of the driver is limited, the at least one processor is configured to:
determine, based on the driver sensor data, a head of the driver is rotated in a position looking away from a road on which the vehicle is traveling for a period of time;
compare the period of time with a predetermined threshold amount of time for the head of the driver looking away from the road; and
determine the FOV of the driver is limited based on the period of time being greater than or equal to the predetermined threshold amount of time.

15. The apparatus of claim 13, wherein the at least one processor is configured to determine an intention to move by the driver based on detecting at least one of a release of a brake pedal of the vehicle, a press of a gas pedal of the vehicle, or a shifting of a transmission of the vehicle to drive.

16. The apparatus of claim 15, wherein the at least one processor is configured to activate a forward collision warning (FCW) based on determining the intention to move by the driver.

17. The apparatus of claim 16, wherein the FCW comprises at least one of a visual display warning, an audio warning, or a vibration.

18. The apparatus of claim 13, wherein the one or more objects comprise at least one of one or more vulnerable road users (VRUs) or one or more other vehicles.

19. The apparatus of claim 13, wherein the at least one processor is configured to obtain the driver sensor data using one or more driver sensors of the vehicle.

20. The apparatus of claim 13, wherein the at least one processor is configured to obtain the traffic sensor data using one or more traffic sensors of the vehicle directed to an environment of the vehicle.

21. The apparatus of claim 13, wherein the at least one processor is configured to obtain the traffic sensor data from at least one of another vehicle or a roadside unit (RSU).

22. The apparatus of claim 13, wherein the at least one processor is configured to determine the FOV of the driver based on a pre-determined number of gazes of the driver being within the FOV.

23. The apparatus of claim 13, wherein the at least one processor is configured to determine that the FOV of the driver is limited based on the FOV of the driver being less than the FOV threshold.

24. The apparatus of claim 13, the one or more objects are detected as approaching the vehicle.

25. The apparatus of claim 13, wherein the apparatus is part of the vehicle.

26. The apparatus of claim 13, wherein the apparatus is the vehicle.

27. A non-transitory computer-readable storage medium of a vehicle comprising instructions stored thereon which, when executed by at least one processor, causes the at least one processor to:
determine, based on driver sensor data, a field of view (FOV) of a driver of the vehicle;
determine that the FOV of the driver is limited based on a FOV threshold, wherein the FOV threshold is one of a predetermined threshold angle for the FOV of the driver or a percentage of the predetermined threshold angle for the FOV of the driver;
detect, based on traffic sensor data, one or more objects within a threshold distance relative to the vehicle; and
control an amount of possible acceleration or velocity of the vehicle based on determining the FOV of the driver is limited and detecting the one or more objects within the threshold distance.
